(19) United States
(12) Patent Application Publication
(10) Pub. No.: US 2026/0209045 A1
(43) Pub. Date: Jul. 23, 2026

(54) ANODE ACTIVE MATERIAL FOR A SECONDARY BATTERY, A MANUFACTURING METHOD THEREOF, AND A SECONDARY BATTERY INCLUDING THE SAME

(71) Applicant: Dong-A University Research Foundation For Industry-Academy Cooperation, Busan (KR)

(72) Inventors: Jung Kyoo LEE, Busan (KR); Chan Sik SON, Busan (KR); Jung Woo BAE, Pohang-si (KR); Jae Wook SEO, Geoje-si (KR); Se Eun PARK, Busan (KR)

(73) Assignee: Dong-A University Research Foundation For Industry-Academy Cooperation, Busan (KR)

(21) Appl. No.: 19/450,711

(22) Filed: Jan. 15, 2026

(30) Foreign Application Priority Data
Jan. 23, 2025 (KR) 10-2025-0010071

(51) Int. Cl. C01B 32/05

(52) U.S. Cl. CPC C01B 32/05; C01P 2002/08; C01P 2002/88; C01P 2004/04; C01P 2004/61; C01P 2004/64; C01P 2004/88; C01P 2006/14; C01P 2006/17; C01P 2006/40

(57) ABSTRACT

An anode active material for a secondary battery includes porous silicon particles and carbon-based particles surrounding at least a portion of the porous silicon particles, wherein the porous silicon particles include mesopores therein configured to accommodate volume expansion of silicon during charge and discharge, and the anode active material may have a controlled pore volume and improved structural stability.

### CROSS-REFERENCE TO RELATED APPLICATION

This application claims priority to and the benefit of Korean Patent Application No. 2025-0010071, filed on Jan. 23, 2025, the disclosure of which is incorporated herein by reference in its entirety.

### BACKGROUND

### 1. Field of the Invention

The present disclosure relates to an anode active material for a secondary battery, a manufacturing method thereof, and a secondary battery including the same. More specifically, the present disclosure relates to an anode active material for a secondary battery capable of suppressing volume expansion, a manufacturing method thereof, and a secondary battery including the same.

### 2. Discussion of Related Art

Research on various lithium secondary batteries is being actively conducted to improve the efficiency of electric vehicles and large-capacity energy storage systems. Currently, as the need for secondary batteries as storage devices having high energy density (Wh/kg or Wh/l), high power density (W/kg or W/l), and high stability increases, research and development are being focused on cathode and anode materials, separators, and electrolytes, which are key elements of secondary batteries.

Graphite, which has been used as an anode material since the commercialization of lithium secondary batteries, has advantages of low cost, low operating voltage, and excellent lifespan stability. However, due to its low theoretical capacity of about 372 mAh/g and slow storage (charging) speed of lithium ions resulting in poor rate characteristics, there is a limitation in its application as a high-performance secondary battery anode material. In addition, although the graphite anode material must be coated thicker in accordance with the development of high-capacity cathode materials, when a high current density is applied to the graphite anode material, lithium metal is precipitated due to the slow lithium ion storage speed, forming dendrites. This leads to a problem of increased risk of explosion.

As the need for the development of high-capacity anode materials capable of replacing low-capacity, low-power, and slow charging graphite has emerged, much research is being conducted on Group IV and V metals such as Si, Sn, Ge, Pb, As, and Bi, which electrochemically form an alloy with lithium, as alternative anode materials.

Among them, silicon is one of the most promising anode materials due to its characteristics of relatively low operating voltage (~0.4 V Li/Li⁺) and high theoretical capacity (~3,579 mAh/g), as well as being a very abundant resource on Earth. However, silicon has a problem in that it not only has low electrical conductivity but also reacts with up to about 4 lithium ions per silicon element during repeated charging and discharging, causing a large volume expansion of nearly about 280%, thereby inducing electrode pulverization.

In addition, the reaction between the silicon surface newly generated in this process and the electrolyte continuously generates a Solid Electrolyte Interface (SEI) layer, which causes not only high initial irreversible capacity but also high resistance formation and rapid capacity reduction, thereby shortening the lifespan of the secondary battery.

### SUMMARY OF THE INVENTION

The present invention is directed to providing an anode active material for a secondary battery, a manufacturing method thereof, and a secondary battery including the same.

However, the above object is exemplary, and the scope of the present invention is not limited thereto.

According to one aspect of the present invention, there is provided an anode active material including porous silicon particles and carbon-based particles surrounding at least a portion of the porous silicon particles wherein mesopores are included inside a plurality of the porous silicon particles surrounded by the carbon-based particles The porous silicon particles may include mesopores having a size of 12 to 145 nm.

The porous silicon particles may include small silicon primary particles having a size of 10 to 60 nm.

A pore volume of the anode active material particles may be in a range of 0.1 to 0.5 cm³/g.

The carbon-based particles may surround a surface of the porous silicon particles and may be bonded to mesopores formed on the surface of the porous silicon particles.

Meanwhile, according to another aspect of the present invention, there is provided a method for manufacturing an anode active material for a secondary battery, the method including: an impregnation step of impregnating porous silicon particles with a polymer template; a coating step of coating carbon-based particles on the porous silicon particles impregnated with the polymer template; and a carbonization step of carbonizing the porous silicon particles coated with the carbon-based particles subsequent to the coating step.

In the impregnation step, a pore volume formed inside the anode active material may be controllable by adjusting an amount of the polymer template impregnated into the pores of the porous silicon particles.

The impregnation step comprises impregnating the polymer template in an amount of 5 to 50 vol % of a pore volume of the porous silicon particles.

The impregnation step may include: a dissolving step of dissolving the polymer template in a solvent; an absorption step of adding a predetermined amount of a polymer template solution to the porous silicon particles in small portions to absorbed into pores of the porous silicon particles; and a drying step of evaporating the solvent after the absorption step to obtain the porous silicon particles in which the polymer in impregnated.

The coating step may include: an addition step of adding the carbon-based particles to a solvent; a mixing step of dispersing or stirring the impregnated porous silicon particles, the carbon-based particles, and the solvent; a bonding step of inducing physical or chemical bonding of the carbon-based particles at a predetermined temperature after the mixing step; and an evaporation step of removing the solvent after the bonding step to to surround the impregnated porous silicon particles with the carbon-based particles.

After the coating step, the impregnated polymer template may be thermally decomposed and the carbon-based particles bonded to the porous silicon particles may be carbonized by heating under an oxygen-free inert gas atmosphere or a mixed atmosphere of an inert gas and hydrogen.

The carbonization step may be performed by increasing a temperature to a range of 200 to 1200° C.

After the carbonization step, a process of the method may further include additionally pulverizing the anode active material and sieving the pulverized material to obtain particles having a size of 5 to 45 μm.

Meanwhile, according to still another aspect of the present invention, there is provided a secondary battery including an anode active material having porous silicon particles and carbon-based particles surrounding at least a portion of the porous silicon particles, wherein mesopores are included inside a plurality of the porous silicon particles surrounded by the carbon-based particles.

The porous silicon particles may include mesopores having a size of 12 to 145 nm.

The porous silicon particles may include small silicon primary particles having a size of 10 to 60 nm.

A pore volume of the anode active material particles may be in a range of 0.1 to 0.5 cm³/g.

The carbon-based particles may surround a surface of the porous silicon particles and may be bonded to micropores formed on the surface of the porous silicon particles.

Aspects, characteristics, and advantages other than those described above will be apparent from the following detailed description, claims, and drawings for implementing the present invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates an anode active material for a secondary battery according to an embodiment of the present disclosure.

FIG. 2 is a graph comparing nitrogen adsorption and desorption isotherms of porous silicon particles used in an embodiment of the present disclosure and porous silicon particles impregnated with a polymer template.

FIG. 3 is a graph illustrating pore size distributions of porous silicon particles used in an embodiment of the present disclosure and porous silicon particles impregnated with a polymer template.

FIG. 4 is a graph comparing nitrogen adsorption and desorption isotherms of an anode active material for a secondary battery according to an embodiment of the present disclosure.

FIG. 5 is a graph illustrating a pore size distribution of an anode active material for a secondary battery according to an embodiment of the present disclosure.

FIG. 6 is a schematic view illustrating a method of manufacturing an anode active material for a secondary battery according to an embodiment of the present disclosure.

FIG. 7 shows TEM photographs and element mapping images of cross-sections of anode active material particles for a secondary battery according to Example 1 ((a) of FIG. 7) and Example 3 ((b) of FIG. 7) of the present disclosure, illustrating actual implementation examples of the conceptual and schematic diagrams of FIGS. 1 to 6.

FIG. 8 is a graph comparing charge and discharge cycle performance of anode active materials for secondary batteries according to an Example of the present disclosure and a Comparative Example.

FIG. 9 is a graph illustrating Electrochemical Impedance Spectroscopy (EIS) results before and after cycles of anode active materials for secondary batteries according to an Example of the present disclosure and a Comparative Example.

FIG. 10 is a graph illustrating measured thickness changes of an anode employing an anode active material for a secondary battery according to an embodiment of the present disclosure and an anode employing an anode active material according to a Comparative Example before and after cycles.

FIG. 11 illustrates Thermogravimetric Analysis (TGA) results measured in an air atmosphere for a product according to an embodiment of the present disclosure, and silicon-carbon composites which are anode active materials for secondary batteries according to Examples and Comparative Example.

### DETAILED DESCRIPTION OF EXEMPLARY EMBODIMENTS

Hereinafter, the present invention will be described with reference to the accompanying drawings. Various changes may be made to the present invention, and the invention may have various embodiments, particular embodiments of which will be described in detail with reference to the drawings. However, embodiments according to the concept of the present invention are not construed as limited to the particular embodiments and include all changes and/or equivalents or substitutes that do not depart from the spirit and technical scope of the present invention. In regard to the description of the drawings, like reference numerals refer to like elements.

The term [include], [may include], etc. used in various embodiments of the present invention is to indicate the presence of functions, operations, elements, etc. disclosed herein and does not preclude the presence or addition of one or more functions, operations, elements, etc. In various embodiments of the present invention, the term [include], [have], etc. is to indicate the presence of features, numbers, steps, operations, elements, parts, or combinations thereof described in the specification and does not preclude the presence or addition of one or more other features, numbers, steps, operations, elements, parts, or combinations thereof.

In various embodiments of the present invention, the term [or] or the like includes any one and all combinations of the listed words. For example, [A or B] may include A, B, or both A and B.

While terms [first], [second], etc. used in various embodiments of the present invention may modify various elements of the embodiments, the elements are not limited by the terms. For example, the terms do not limit the sequence and/or importance of the elements. The terms may be used for distinguishing one element from another. For example, both a first user device and a second user device may be user devices and represent different user devices. For example, a first element may be named a second element without departing from the scope of various embodiments of the present invention, and similarly, a second element may be named a first element.

When an element is referred to as being [connected] or [coupled] to another element, it should be understood that the element may be directly connected or coupled to the other element but still another element may also be interposed therebetween. On the other hand, when an element is referred to as being [directly connected] or [directly coupled] to another element, it should be understood that there is no element therebetween.

Terms used in various embodiments of the present invention are for the purpose of describing particular embodiments only and are not intended to limit various embodiments of the present invention. The singular forms are intended to include the plural forms as well unless the context clearly indicates otherwise.

All terms used herein including technical or scientific terms have the same meanings as those generally understood by those skilled in the technical field to which various embodiments of the present invention pertain.

Terms defined in a generally used dictionary should be interpreted as having the same meanings as the contextual meanings of the relevant technology and should not be interpreted as having ideal or exaggerated meanings unless clearly defined in various embodiments of the present invention.

In the following descriptions, a system may be any one, some, or all of a configuration of devices, an operating method of the devices, a computer program for executing the operating method of the devices, and a medium on which the computer program is recorded.

An aspect of the present disclosure provides an anode active material for a secondary battery including a porous silicon-carbon composite. More specifically, the anode active material for a secondary battery includes porous silicon particles and carbon-based particles surrounding at least a portion of the porous silicon particles.

In this case, the porous silicon particle 1 includes a plurality of fine pores, and the fine pores may be mesopores. Due to the presence of fine pores inside the porous silicon particles, volume expansion is effectively absorbed even during repeated lithiation and de-lithiation, thereby maintaining structural stability.

Hereinafter, the terms “micropores” or “mesopores” collectively refer to pores having a size of approximately 12 to approximately 145 nm.

Hereinafter, porous silicon will be referred to as [pSi.]

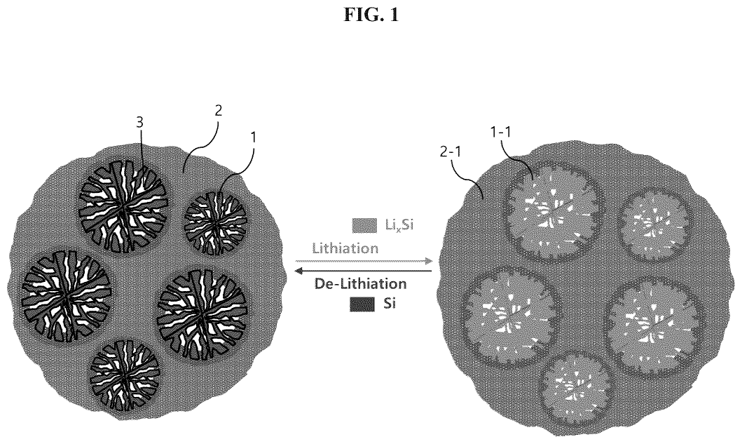

FIG. 1 illustrates an anode active material for a secondary battery according to an embodiment of the present disclosure. Referring to FIG. 1, the porous silicon particles 1 may be formed from a silicon precursor. More specifically, as will be described later, the porous silicon particles 1 may be composed of a plurality of silicon primary particles having a size of approximately 10 to approximately 60 nm.

As a raw material, the silicon precursor may be at least one selected from among known silicon-containing materials, including silicon dioxide (SiO₂), silicon oxide (SiOₓ, where 0<x<2), silica gel, sand, glass, quartz, zeolite, and fumed silica, each having various forms and particle sizes.

The carbon-based particles surrounding at least a portion of the porous silicon particles 1 may include at least one selected from the group consisting of pitch, sucrose, glucose, resorcinol-formaldehyde, phenol-formaldehyde, phenolic resin, polydopamine, graphite, carbon black, carbon nanotubes, and graphene.

More specifically, the carbon-based particles 2 may surround the porous silicon particles 1 so as to entirely or partially cover the porous silicon particles.

The carbon-based particles 2 may be bonded to micropores formed on surfaces of the porous silicon particles. Accordingly, the carbon-based particles 2 may be bonded mainly to the surfaces of the porous silicon particles rather than to interiors thereof, thereby surrounding the porous silicon particles. As used herein, [bonded] may include physical bonding, chemical bonding, or physical-chemical bonding.

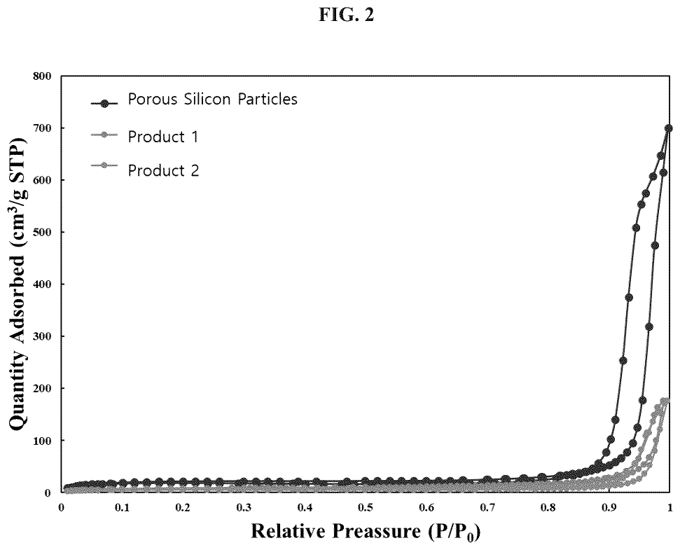

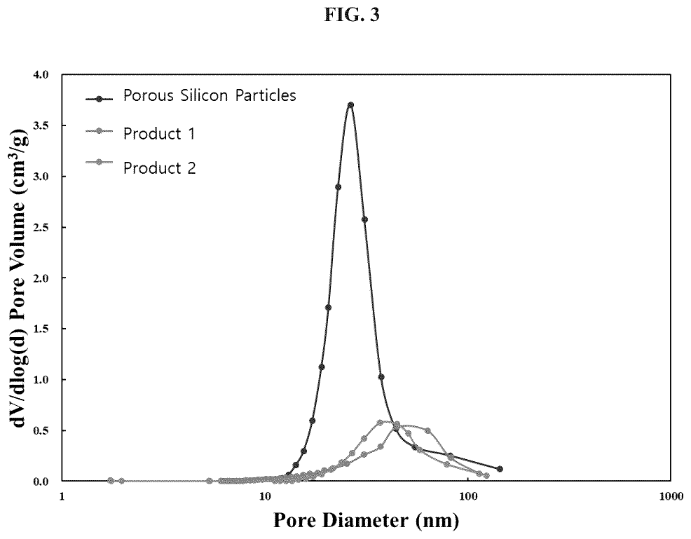

As shown in FIGS. 2 and 3, the porous silicon particles 1 used in the anode active material for a secondary battery include mesoporous micropores 3, and the micropores 3 may have a size in a range of approximately 12 nm to approximately 145 nm.

More specifically, as shown in FIGS. 2 and 3, the porous silicon particles (1) used in the anode active material for a secondary battery include mesopores (3), and the mesopores (3) may have a size in a range of approximately 12 nm to approximately 145 nm.

When the micropore size is smaller than the lower limit, volume expansion described below may not be sufficiently suppressed, and when the micropore size exceeds the upper limit, the micropores may act as resistance, making it difficult to achieve sufficient capacity expression.

As shown in FIG. 2, in one embodiment, in a product obtained by impregnating polystyrene (PS) as a polymer template, pores of the porous silicon are filled with the polymer template, resulting in a significant reduction in nitrogen adsorption and desorption amounts.

In addition, as shown in FIG. 3, the micropores of the porous silicon particles used in the anode active material for a secondary battery may have a size in a range of approximately 12 nm to approximately 145 nm.

As shown in FIG. 2, nitrogen adsorption and desorption amounts are significantly reduced after impregnation of the polymer template, and at the same time, as shown in FIG. 3 and Table 1, it can be confirmed that a Brunauer-Emmett-Teller (BET) surface area and a pore volume are significantly reduced.

Herein, the pore volume refers to a total pore volume derived at a single desorption point (e.g., P/P₀=0.995) during a desorption process in a BET analysis, that is, a single-point desorption total pore volume.

By way of example, a BET surface area and a pore volume of porous silicon were approximately 84.0 m²/g and approximately 1.05 cc/g, respectively. However, in Product 1 (PS@pSi(15 vol %)), in which a polymer template was impregnated into porous silicon particles in an amount of approximately 15 vol %, the BET surface area and the pore volume were significantly reduced to approximately 29.9 m²/g and approximately 0.27 cc/g, respectively. In Product 2 (PS@pSi(30 vol %)), in which a polymer template was impregnated into porous silicon particles in an amount of 30 vol %, the BET surface area and the pore volume were further reduced to approximately 23.2 m²/g and approximately 0.27 cc/g, respectively.

These results confirm that the polymer template is successfully impregnated into micropores inside the porous silicon particles and that the impregnation amount can be controllably adjusted.

TABLE 1

| | BET surface | Pore volume | Average Pore |
|---|---|---|---|
| Item | area (m²/g) | (cm³/g) | size (nm) |
| Porous Silicon (pSi) | 84.1 | 1.05 | 29.51 |
| Product 1 | 29.9 | 0.27 | 40.03 |
| (PS@pSi(15 vol %)) | | | |
| Product 2 | 23.2 | 0.27 | 39.5 |
| (PS@pSi(30 vol %)) | | | |

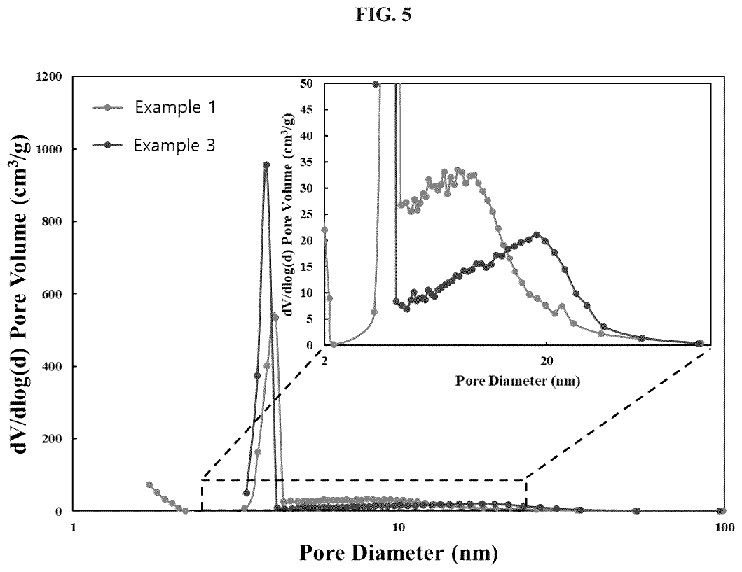

As shown in FIG. 5, micropores of the anode active material for a secondary battery may have a size in a range of approximately 12 nm to approximately 145 nm. In particular, among the pore volume, a volume ratio of mesopores (i.e., a ratio of a volume of mesoporous micropores to a total pore volume) may be 30% or more.

When the pore size is smaller than the lower limit, volume expansion described below may not be suppressed to a desired level, and when the pore size exceeds the upper limit, resistance within an electrode may increase, thereby making it difficult to sufficiently achieve capacity expression.

The anode active material for a secondary battery may have a particle size in a range of approximately 5 μm to approximately 45 μm. Accordingly, the above-described volume expansion suppression effect can be further improved.

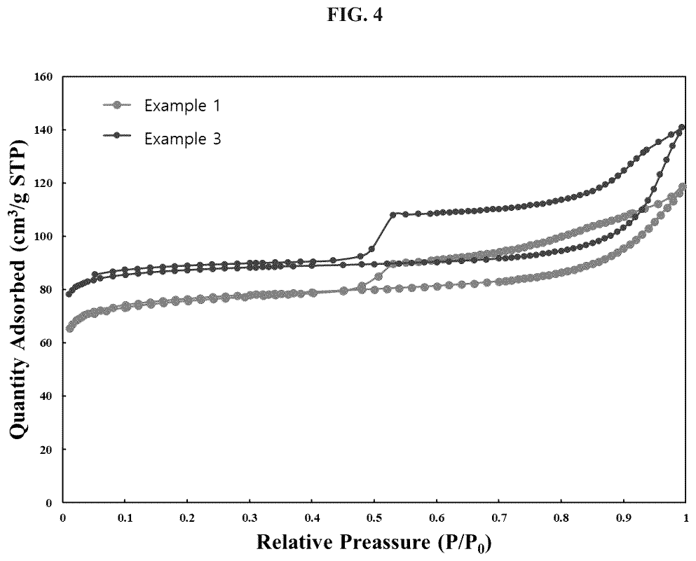

As shown in FIG. 4, according to nitrogen adsorption-desorption isotherm analysis of the anode active material for a secondary battery, a clear hysteresis between adsorption and desorption isotherms is observed in a range of P/P₀=approximately 0.5 to approximately 1.0, confirming that the anode active material includes mesoporous micropores.

When an impregnation amount of the polymer template is relatively large, the polymer template is thermally decomposed and removed during a carbonization process, thereby increasing a volume of micropores. Accordingly, a nitrogen adsorption amount is also increased, and as compared in Table 2, it can be confirmed that both the pore volume and an average pore size are increased.

TABLE 2

| Item | Pore volume (cm³/g) | Average Pore size (nm) |
|---|---|---|
| Example 1 | 0.17 | 6.73 |
| (v-pSi@C(15 vol %) | | |
| Example 3 | 0.22 | 6.87 |
| (v-pSi@C(30 vol %) | | |

Meanwhile, referring to Table 2, with respect to a pore volume of the anode active material for a secondary battery, it is preferable that the pore volume is within a broad range of approximately 0.1 to approximately 0.5 cc/g.

More preferably, the pore volume may be within a narrower range of approximately 0.17 to approximately 0.5 cc/g, approximately 0.22 to approximately 0.5 cc/g, approximately 0.1 to approximately 0.17 cc/g, approximately 0.1 to approximately 0.22 cc/g, or approximately 0.17 to approximately 0.22 cc/g.

When the pore volume is smaller than the lower limit, an effect of absorbing volume expansion may be negligible or insufficient, and when the pore volume exceeds the upper limit, the pore volume may act as resistance, making capacity expression difficult and causing a problem in that electrode volume increases due to low density.

Meanwhile, as shown in Table 2, micropores of the anode active material for a secondary battery may have an average pore size of approximately 5 nm to approximately 15 nm.

Preferably, the average pore size may be within a range of approximately 6.73 nm to approximately 15 nm, approximately 6.87 nm to approximately 15 nm, approximately 5 nm to approximately 6.73 nm, approximately 5 nm to approximately 6.87 nm, or approximately 6.73 nm to approximately 6.87 nm. When the average pore size of the micropores is smaller than the lower limit, a volume expansion rate described below may not be suppressed to a desired level. When the average pore size exceeds the upper limit, resistance within an electrode may increase, thereby causing a problem in that sufficient capacity expression cannot be achieved.

Herein, the term [average pore size] refers to an average pore size derived from nitrogen adsorption-desorption isotherm analysis data for BET surface area analysis, using a BJH (Barrett-Joyner-Halenda) model during a desorption process.

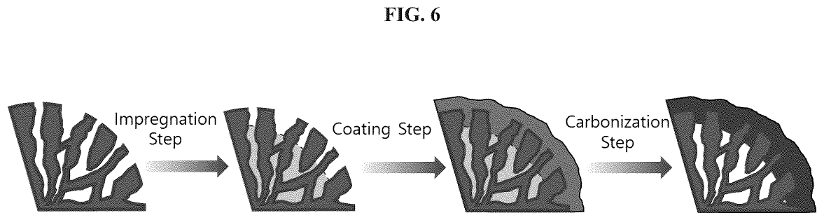

FIG. 6 is a diagram illustrating a method for manufacturing the above-described anode active material for a secondary battery. The manufacturing method according to the present embodiment includes an impregnation step, a coating step, and a carbonization step.

The impregnation step is a step of impregnating a polymer template into porous silicon particles. For example, a polymer template may be added to the porous silicon particles and impregnated by stirring under room temperature and atmospheric pressure conditions. In this case, the polymer template may be polystyrene.

However, the polymer template is not limited thereto, and may be selected from at least one of various types of organic particles decomposable by heat, polyethylene, polynorbornene, polyarylenealkylene, SEBS (poly(styrene-b-ethylene-co-butylene-b-styrene)), polyvinyl chloride, polypropylene, polyurethane, polyamide, polycarbonate, polybutadiene, and polyisoprene.

As shown in FIG. 6, the polymer template fills micropores of the porous silicon particles. In this case, the polymer template may be impregnated starting from a central region of the porous silicon particles, and an amount of the polymer template may be controlled such that surfaces of the porous silicon particles are not impregnated.

More specifically, the polymer template may be impregnated in an amount of approximately 5% to approximately 50% of a pore volume of the porous silicon particles.

When the impregnation amount is smaller than the lower limit, a volume expansion rate may not be suppressed to a desired level, and when the impregnation amount exceeds the upper limit, pores formed thereafter may act as resistance, making it difficult to sufficiently achieve capacity expression.

After the impregnation step and before the coating step, the method may further include a drying step of drying the impregnated porous silicon particles, and a first obtaining step of obtaining impregnated porous silicon particles having a size equal to or smaller than a predetermined size by using a sieve of a predetermined size.

The impregnation step may control the pore volume formed inside the anode active material by adjusting the amount of polymer template impregnated into the pores of the porous silicon particles.

The coating step includes coating carbon-based particles on the porous silicon particles impregnated with the polymer template.

More specifically, the coating step includes an addition step, a mixing step, a bonding step, and an evaporation step. Depending on a type of the carbon-based particles, a dehydration condensation step may be additionally performed after the evaporation step.

In the addition step, carbon-based particles and a solvent (e.g., ethanol) are added to the porous silicon particles impregnated with the polymer template. In this case, the carbon-based particles may include at least one selected from the group consisting of pitch, sucrose, glucose, resorcinol-formaldehyde, phenol-formaldehyde, phenolic resin, polydopamine, graphite, carbon black, carbon nanotubes, and graphene.

The mixing step may disperse the impregnated porous silicon particles, the carbon-based particles, and the solvent. For example, in the mixing step, the impregnated porous silicon particles, the carbon-based particles, and the solvent may be subjected to ultrasonic treatment at approximately 20 kHz to approximately 40 kHz for approximately 20 minutes to approximately 1 hour at room temperature.

The bonding step induces physical or chemical bonding of the carbon-based particles at a predetermined temperature after the mixing step. For example, sulfuric acid may be added to the impregnated porous silicon particles, the carbon-based particles, and the solvent, and stirring may be performed using a magnetic bar to form an eddy.

Through this process, in the bonding step, the carbon-based particles can be coated on the impregnated porous silicon particles. Hereinafter, porous silicon particles coated with the carbon-based particles are referred to as [impregnated-and-coated porous silicon particles.]

The evaporation step is a step of evaporating the solvent by heating the impregnated-and-coated porous silicon particles and the solvent after the mixing step. For example, in the evaporation step, the solvent may be evaporated by stirring at a predetermined speed (e.g., approximately 200 rpm to approximately 400 rpm) in an oil bath at approximately 80° C. to approximately 120° C.

Depending on a type of the carbon-based particles, a dehydration condensation step may be further performed. The dehydration condensation step may induce a dehydration condensation reaction by heating the impregnated-and-coated porous silicon particles at a predetermined temperature after the evaporation step. In this case, the predetermined temperature may be approximately 140° C. to approximately 180° C., and the dehydration condensation reaction may be induced for approximately 5 hours to approximately 7 hours.

In this case, after the dehydration condensation reaction, the method may further include a first pulverization step of pulverizing the impregnated-and-coated porous silicon particles.

Referring again to FIG. 6, after the coating step, a carbonization step is performed to carbonize the impregnated-and-coated porous silicon particles.

The carbonization step forms a carbonization atmosphere of an inert gas atmosphere or a mixed gas atmosphere of an inert gas and hydrogen, and heats the impregnated-and-coated porous silicon particles to a predetermined temperature to thermally decompose the polymer template impregnated therein while simultaneously carbonizing a carbon precursor.

The carbonization step forms a carbonization atmosphere of an inert gas atmosphere or a mixed gas atmosphere of an inert gas and hydrogen. The carbonization step heats the impregnated-and-coated porous silicon particles to a predetermined temperature to thermally decompose the polymer template impregnated in the impregnated-and-coated porous silicon particles while simultaneously carbonizing a carbon precursor.

In the carbonization step, the polymer template impregnated inside the porous silicon particles of the impregnated-and-coated porous silicon particles is thermally decomposed and removed, and the carbon precursor is carbonized. Accordingly, the impregnated-and-coated porous silicon particles become a secondary battery active material having micropores formed inside the porous silicon particles and a shell composed of carbon-based particles on an outer surface thereof.

In this case, the predetermined temperature of the carbonization step may be in a range of approximately 200° C. to approximately 1200° C. When the temperature is lower than approximately 200° C., carbon purity and electrical conductivity may be reduced, and when the temperature exceeds approximately 1200° C., silicon may be melted.

For example, the carbonization step may be performed under an argon (Ar) atmosphere or an Ar (5% H₂) gas atmosphere, and a temperature may be continuously or stepwise increased from approximately 200° C. to approximately 1200° C.

The method for manufacturing an anode active material for a secondary battery may further include, after the carbonization step, a second pulverization step and a second obtaining step.

The second pulverization step is a step of pulverizing the secondary battery active material (e.g., porous silicon particles coated with carbon-based particles) after the carbonization step.

The second obtaining step is a step of obtaining a secondary battery active material having a size equal to or smaller than a predetermined size by using a sieve of a predetermined size. In this case, the secondary battery active material having a particle size of approximately 5 μm to approximately 45 μm may be obtained by using the sieve.

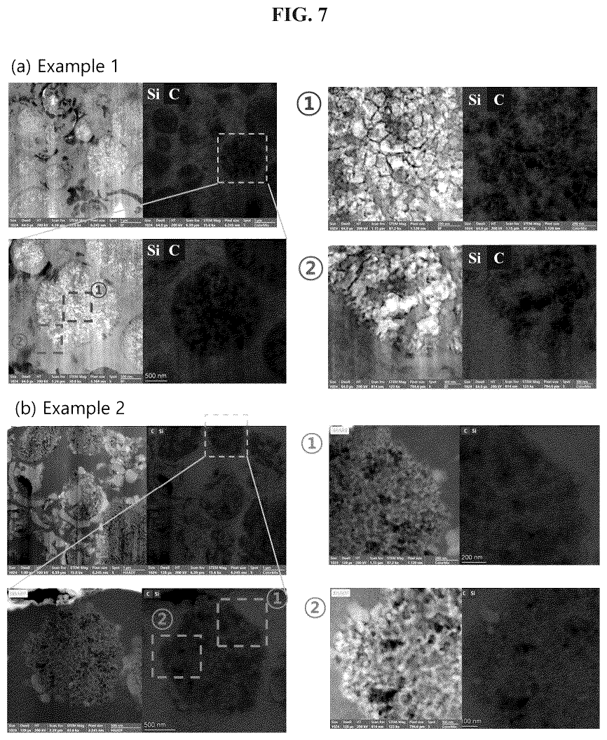

As shown in FIG. 7, the prepared porous silicon particles coated with carbon-based particles show that an entire interior thereof is not filled with carbon, and that void spaces are mainly present inside the porous silicon particles at locations where the polymer template was previously positioned.

In this case, as an amount of the polymer template impregnated into the porous silicon particles increases, the void spaces increase in size. Accordingly, an amount of the void spaces inside the particles can be controlled by adjusting the impregnation amount of the polymer template.

Meanwhile, the method for manufacturing an anode active material for a secondary battery may further include a porous silicon particle manufacturing step of obtaining porous silicon particles from a silicon precursor.

In this case, the porous silicon particle manufacturing step may include:
(i) a first heat-treating step of heat-treating a first mixture including a silicon precursor and a thermal dispersant;
(ii) a step of adding and stirring a metal reducing agent into the first mixture to form a second mixture;
(iii) a second heat-treating step of heat-treating the second mixture in a rotary reaction chamber; and
(iv) a step of washing the second mixture after the second heat treatment with a solvent to recover porous silicon particles.

Hereinafter, the present invention will be described in more detail with reference to Examples, Preparation Examples, and Experimental Examples of an anode active material for a secondary battery. However, the following descriptions are not intended to limit the scope of the present invention.

### Examples 1 to 3: Preparation of Anode Active Material for Secondary Battery

### Example 1: Preparation of Anode Active Material for Secondary Battery (v-pSi@C (15 Vol %))

Preparation of Porous Silicon (pSi)

### <Dynamic Magnesiothermic Reduction of Silica (DMR of Silica)>

A method of preparing porous silicon from silica by rotating a reactor and performing magnesiothermic reduction was referred to as Dynamic Magnesiothermic Reduction (DMR).

Silica (approximately 10 g) to be used as a precursor and a thermal dispersant NaCl (approximately 100 g) were placed in a 1 L beaker, and distilled water (approximately 800 mL) was added thereto, followed by uniform mixing at approximately 350 rpm for approximately 3 hours.

Thereafter, the mixture was transferred to an oil bath at approximately 120° C., and stirring was continued at approximately 350 rpm to completely evaporate the solvent. The resulting mixture was then collected and dried in an oven at approximately 80° C.

After drying, hydroxyl groups (Si—OH) were present on surfaces of the silica in the mixture, which interfere with the reduction reaction. Accordingly, the hydroxyl groups were removed by heat treatment at approximately 700° C. for approximately 5 hours in a furnace under an air atmosphere.

After the heat treatment, the resulting mixture was uniformly pulverized using a mortar, and approximately 110 g thereof was weighed and uniformly mixed with a reducing agent Mg (approximately 0.85 g, molar ratio of approximately 1:2.1) in the mortar. The mixture was then loaded into a rotary reactor, sealed, and the reaction was initiated.

To maintain an argon (Ar) atmosphere inside the reactor, Ar gas was supplied at a flow rate of approximately 300 cc/min, and the reactor was rotated at a speed of approximately 20 rpm during the reaction.

With respect to temperature conditions, the temperature was increased from room temperature at a rate of approximately 10° C./min and maintained at approximately 300° C. for approximately 1.5 hours to remove moisture, and then further increased at a rate of approximately 5° C./min and maintained at approximately 770° C. for approximately 5 hours.

### <H₂O Washing>

After the reaction, the resulting product was collected in a 1 L beaker, and distilled water (approximately 800 mL) was added thereto, followed by stirring at approximately 350 rpm for approximately 30 minutes to dissolve NaCl. The resulting mixture was subjected to vacuum filtration using a membrane filter having a pore size of approximately 0.45 μm.

This filtration process was repeated approximately four times to completely remove NaCl, and the sample retained on the filter was then dried in an oven at approximately 80° C.

### <HCl Washing>

The dried sample obtained after the H₂O washing was collected and divided into two 1 L beakers. For removal of MgO, Mg₂Si, and the like, an HCl solution having a concentration of approximately 2.5 M was added in an amount of approximately 600 mL to each beaker. The HCl solution was slowly added using a dropper while monitoring the reaction.

Thereafter, the mixture was stirred at approximately 350 rpm for approximately 5 hours, followed by vacuum filtration using a membrane filter. The filtered sample was washed with distilled water until neutrality was confirmed, and then dried in an oven at approximately 80° C.

### <HF Etching>

The dried sample obtained after the HCl washing was collected and divided into approximately 250 mL polypropylene (PP) bottles. To remove unreacted SiO₂, an HF solution diluted to approximately 5 wt % was added, followed by stirring for approximately 3 hours.

An amount of the HF solution was used in an excess of approximately five times a stoichiometric reaction ratio, assuming that a composition of the collected sample was approximately 100% SiO₂.

After stirring, the sample was transferred to PP tubes and subjected to centrifugation, and then recovered and washed with distilled water and ethanol by vacuum filtration using a membrane filter. Thereafter, the sample was dried in an oven at approximately 80° C. to obtain high-purity porous silicon (pSi) particles.

### Preparation of Anode Active Material for Secondary Battery by Carbon Coating on Porous Silicon

### <Impregnation Step>

Approximately 0.2 g of polystyrene was dissolved in approximately 5.41 mL of THF (tetrahydrofuran) to prepare an approximately 4 wt % polystyrene solution. The prepared polystyrene solution was added to approximately 0.2 g of the previously prepared porous silicon (pSi) in portions of approximately 200 μL each, and the process of mixing with a spoon was repeated to impregnate a total amount of approximately 916 μL in a dropwise manner.

In this case, an amount of the impregnated polystyrene was calculated based on a pore volume of the porous silicon particles (BET result, pore volume=approximately 1.05 cm³/g).

After drying, the impregnated porous silicon was sieved using a approximately 45 μm sieve to obtain porous silicon impregnated with approximately 15 vol % polystyrene (Product 1, PS@pSi (15 vol %)).

### <Carbon Coating Step>

Porous silicon impregnated with approximately 15 vol % polystyrene (approximately 0.2 g; Product 1, PS@pSi (15 vol %)) and sucrose (approximately 0.45 g) were placed in a approximately 20 mL vial together with an ethanol solvent (approximately 6.25 mL of approximately 10 vol % ethanol), and dispersed using an ultrasonic cleaner for approximately 30 minutes.

While stirring at approximately 300 rpm, sulfuric acid (approximately 28 μL) was added, and stirring was continued for approximately 30 minutes. The mixture was then transferred to an oil bath at approximately 100° C., and stirring was maintained at approximately 300 rpm to completely evaporate the solvent.

The vial was recovered as is, and an additional dehydration condensation reaction was carried out in a furnace at approximately 160° C. for approximately 6 hours. Thereafter, the sample was collected and finely ground using a mortar and pestle.

### <Carbonization Step>

The sample was transferred into a crucible, and carbonization was performed in a tube furnace. A carbonization atmosphere was maintained by supplying an Ar (5% H₂) gas at a flow rate of approximately 300 cc/min, and the carbonization temperature was controlled according to the following steps.

Specifically, the temperature was increased from room temperature to approximately 200° C. at a rate of approximately 2° C./min and maintained for approximately 30 minutes, then increased to approximately 325° C. at a rate of approximately 2° C./min, further increased to approximately 475° C. at a rate of approximately 1° C./min, and then increased to approximately 850° C. at a rate of approximately 2° C./min and maintained for approximately 7 hours.

After carbonization, the sample was ground using a pestle, and particles having a size of approximately 5 μm to approximately 45 μm were obtained using a sieve. The resulting product was designated as Example 1—anode active material for a secondary battery (v-pSi@C (15 vol %)).

### Example 2: Preparation of Anode Active Material for Secondary Battery (v-pSi@C (20 Vol %))

Except for the following differences, an anode active material for a secondary battery according to Example 2 (v-pSi@C (20 vol %)) was prepared in the same manner as in Example 1.

### <Impregnation>

A approximately 4 wt % polystyrene solution identical to that used in Example 1 was impregnated into approximately 0.2 g of pSi in an amount of approximately 1222 μL. After drying and sieving, porous silicon particles impregnated with approximately 20 vol % polystyrene (PS@pSi (20 vol %)) were obtained.

### <Carbon Coating and Carbonization>

Porous silicon particles impregnated with approximately 20 vol % polystyrene (approximately 0.2 g; PS@pSi (20 vol %)) and sucrose (approximately 0.43 g) were dispersed in an ethanol solvent (approximately 6.05 mL of approximately 10 vol % ethanol). Sulfuric acid (approximately 28 μL) was added, and thereafter, solvent evaporation, additional dehydration condensation at approximately 160° C., carbonization, and sieving were sequentially performed to obtain an anode active material for a secondary battery according to Example 2 (v-pSi@C (20 vol %)).

### Example 3: Preparation of Anode Active Material for Secondary Battery (v-pSi@C (30 Vol %))

Except for the following differences, an anode active material for a secondary battery according to Example 3 (v-pSi@C (30 vol %)) was prepared in the same manner as in Example 1.

### <Impregnation>

A approximately 4 wt % polystyrene solution identical to that used in Example 1 was impregnated into approximately 0.2 g of pSi in an amount of approximately 1833 μL. After drying and sieving, porous silicon impregnated with approximately 30 vol % polystyrene (Product 3, PS@pSi (30 vol %)) was obtained.

### <Carbon Coating and Carbonization>

Porous silicon impregnated with approximately 30 vol % polystyrene (approximately 0.2 g) and sucrose (approximately 0.42 g) were dispersed in an ethanol solvent (approximately 5.9282 mL of approximately 10 vol % ethanol). Sulfuric acid (approximately 26 μL) was added, and thereafter, solvent evaporation, additional dehydration condensation at approximately 160° C., carbonization, and sieving were sequentially performed to obtain an anode active material for a secondary battery according to Example 3 (v-pSi@C (30 vol %)).

### Preparation Examples 1 to 3 and Comparative Example 1: Preparation of Lithium Secondary Battery

### Preparation Example 1

### <Preparation of Secondary Battery Anode>

A slurry having a total solid content of approximately 0.2 g was prepared using, as an anode active material for a secondary battery, the anode active material of Example 1, a conductive material, and a binder at a weight ratio of approximately 8:1:1.

The conductive material included approximately 0.5 wt % single-walled carbon nanotubes (SW-CNTs) and approximately 9.5 wt % Super P, and the binder was used at a weight ratio of approximately 1:1 of styrene-butadiene rubber (SBR) to carboxymethyl cellulose (CMC).

Herein, the SW-CNT solution had a concentration of approximately 0.4 wt %, the SBR solution had a concentration of approximately 40 wt %, and the CMC solution had a concentration of approximately 2 wt %, each being dispersed or dissolved in water for use.

The solid content was adjusted with distilled water and set to approximately 18.25 wt %.

The prepared slurry was applied onto a copper foil current collector having a thickness of approximately 9 μm using a coating blade set to approximately 25 μm, and then dried in an oven at approximately 80° C. After drying, the thickness was measured, and the coated electrode was roll-pressed to achieve approximately 70% of the thickness, thereby preparing a secondary battery anode.

### <Cell Assembly>

In order to prepare a half-cell using the prepared electrode as a working electrode, the previously prepared anode was dried under vacuum at approximately 110° C. for approximately 6 hours to approximately 12 hours, and then transferred into an argon (Ar) atmosphere glove box for assembly.

2032 coin cell components and a Celgard 2400 separator were used. As an electrolyte, a product in which approximately 10% fluoroethylene carbonate (FEC) as an additive was dissolved in a mixed organic solvent of ethyl carbonate, ethyl methyl carbonate, and diethyl carbonate (EC:EMC:DEC=approximately 3:4:3 (v/v)) containing approximately 1.2 M lithium salt LiPF₆ was used, thereby preparing a lithium secondary battery.

### Preparation Example 2

A lithium secondary battery was prepared in the same manner as in Preparation Example 1, except that the anode active material of Example 2 was used instead of the anode active material of Example 1.

### Preparation Example 3

A lithium secondary battery was prepared in the same manner as in Preparation Example 1, except that the anode active material of Example 3 was used instead of the anode active material of Example 1.

### Comparative Example 1

Except for the following differences, an anode active material for a secondary battery according to Comparative Example 1 (SiMP@C) was prepared in the same manner as in Preparation Example 1.

Commercial silicon microparticles (SiMP; approximately 0.2 g) and sucrose (approximately 0.51 g) were dispersed in an ethanol solvent (approximately 7.20 mL of approximately 10 vol % ethanol). The SiMP particles used herein had an average particle size of approximately 2.1 μm, which is similar to an average particle size of the porous silicon particles (approximately 1.8 μm). However, unlike the porous silicon particles, the SiMP particles are solid particles having no pores inside.

Sulfuric acid (approximately 32 μL) was added, and thereafter, solvent evaporation, additional dehydration condensation at approximately 160° C., carbonization, and sieving were sequentially performed to obtain an anode active material for a secondary battery according to Comparative Example 1 (SiMP@C).

### Experimental Example 1: Evaluation of Electrochemical Characteristics of Lithium Secondary Battery

In order to analyze electrochemical characteristics of lithium secondary batteries using the anode active materials of Examples 1 to 3 (porous silicon particles coated with carbon-based particles, v-pSi@C) and the anode active material of Comparative Example 1 (SiMP@C), charge and discharge cycling characteristics were evaluated using a constant current method within a voltage range of approximately 0.01 V to approximately 1.5 V.

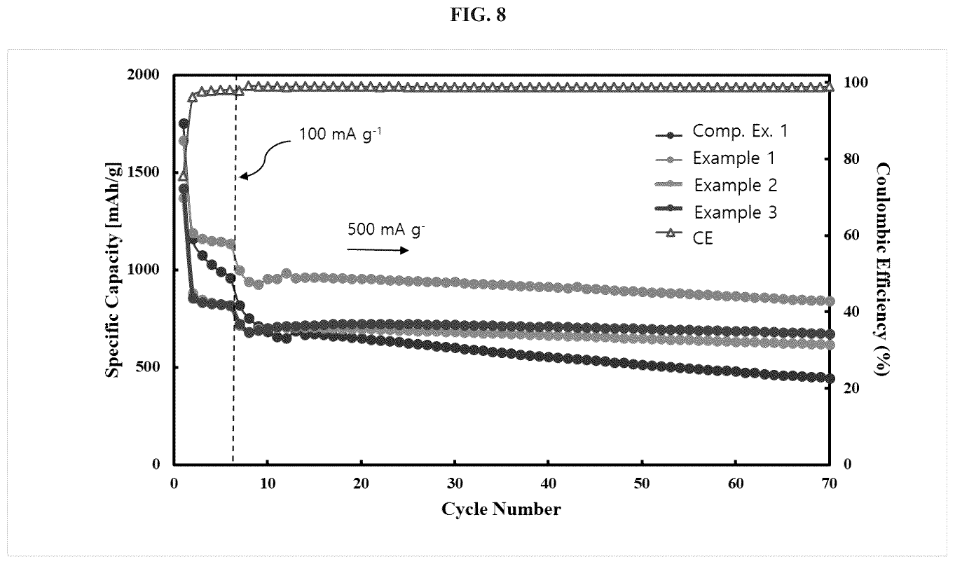

Specifically, the half-cells prepared according to Examples 1 to 3 and Comparative Example 1 were subjected to charge-discharge tests within a voltage range of approximately 0.01 V to approximately 1.5 V (vs. Li/Li⁺) under the following conditions: one cycle at a current density of approximately 50 mA/g, five cycles at approximately 100 mA/g, and seventy cycles at approximately 500 mA/g. The results are shown in Table 3 and FIG. 8.

TABLE 3

| Item | Comp. Ex 1 | Ex 1 | Ex 2 | Ex 3 |
|---|---|---|---|---|
| TGA Result | C 51.9%/ | C 48.3%/ | C 55.0%/ | C 55.7%/ |
| | Si 48.1% | Si 51.7% | Si 45.0% | Si 44.3% |
| Initial Discharge Cap | 1752.3 | 1662.8 | 1368.9 | 1418.3 |
| (mAh/g, 50 mA/g) | | | | |
| Initial Coulombic Eff | 73.6 | 75.6 | 69.3 | 66.3 |
| (%) | | | | |
| Avg Rev. Cap | 1042.3 | 1157.1 | 840.8 | 831.7 |
| (mAh/g, 100 mA/g) | | | | |
| Cap. Retention | 83.4 | 95.4 | 92.7 | 95.7 |
| (%, 100 mA/g) | | | | |
| 13th Cyc Cap | 687.1 | 959.9 | 704.6 | 713.2 |
| (mAh/g, 500 mA/g) | | | | |
| 70th Cyc Cap | 443.4 | 840.1 | 617.5 | 673.4 |
| (mAh/g, 500 mA/g) | | | | |
| Cap. Retention | 64.5 | 87.5 | 87.6 | 94.4 |
| (%, 500 mA/g) | | | | |

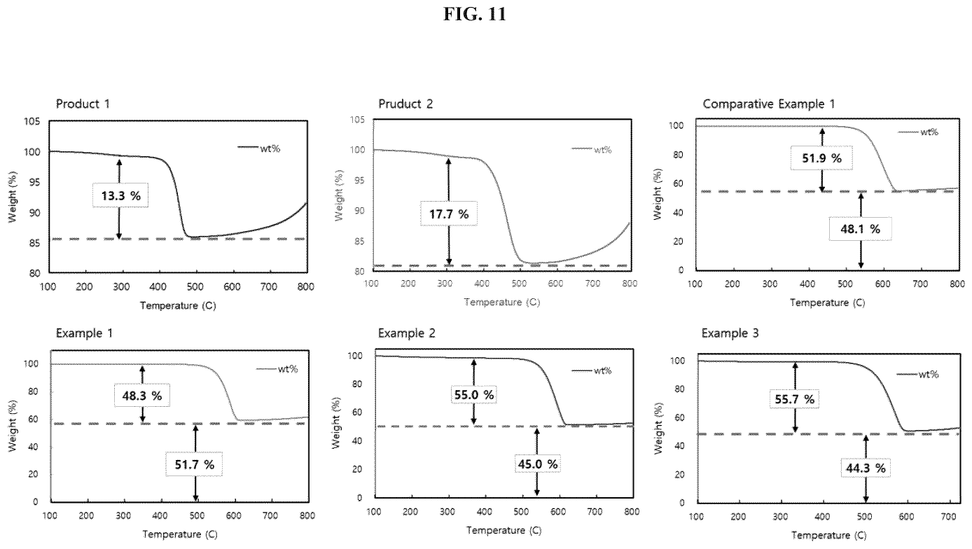

According to TGA analysis results shown in FIG. 11, although carbon-to-silicon composition ratios of Comparative Example 1 and Examples 1 to 3 are similar, it can be seen that capacity retention differs significantly, as shown in Table 3.

Accordingly, from Table 3 and FIG. 8, it can be confirmed that, as the number of cycles increases, Examples 1 to 3 exhibit significantly higher capacity and longer cycle life characteristics compared to Comparative Example 1.

As shown in Table 3 and FIG. 8, it is analyzed that, as the number of cycles increases, the anode active materials according to Examples 1 to 3 exhibit markedly superior capacity retention compared to the anode active material according to Comparative Example 1.

Comparative Example 1 exhibited the largest initial discharge capacity of approximately 1752.3 mAh/g. However, at a current density of approximately 100 mA/g, the capacity continuously decreased, resulting in a low capacity retention of approximately 83.4%.

Even at a current density of approximately 500 mA/g, the capacity continued to decrease, showing a very low capacity retention of approximately 64.5% at the 70th cycle, and a correspondingly low capacity of only approximately 443.4 mAh/g at the 70th cycle.

These cycling results of Comparative Example 1 can be interpreted as a consequence of an inability to accommodate volume expansion of silicon.

Example 1 exhibited a slightly lower initial discharge capacity of approximately 1662.8 mAh/g and an initial Coulombic efficiency compared to Comparative Example 1. Unlike Comparative Example 1, at a current density of approximately 100 mA/g, Example 1 showed a high capacity retention of approximately 95.4%, and an average reversible capacity of approximately 1157.1 mAh/g, which is greater than that of Comparative Example 1.

This trend was similarly observed at a current density of approximately 500 mA/g, and compared to Comparative Example 1, markedly superior cycling performance was confirmed, with a capacity retention of approximately 87.5% and a capacity of approximately 840.1 mAh/g after 70 cycles.

Since silicon contents of the anode active materials according to Examples 2 and 3 are lower than those of the anode active materials according to Comparative Example 1 and Example 1, relatively lower initial discharge capacities of approximately 1368.9 mAh/g and approximately 1418.3 mAh/g, respectively, were exhibited.

However, Examples 2 and 3 showed high initial capacity retentions of approximately 92.7% and approximately 95.7%, respectively, at a current density of approximately 100 mA/g.

Such high capacity retentions were also observed at a current density of approximately 500 mA/g, showing values of approximately 87.6% and approximately 94.4%, respectively, after 70 cycles. Despite the lower initial discharge capacities, it can be confirmed that capacities of approximately 617.5 mAh/g and approximately 673.4 mAh/g, respectively, were achieved after 70 cycles, which are higher than that of Comparative Example 1.

Based on the above results, Examples 1 to 3 of the present invention exhibited superior cycling stability in both initial and long-term cycling compared to Comparative Example 1. This superior performance can be interpreted as a result of structural advantages of the anode active material particles according to the present invention, which effectively accommodate volume expansion of silicon.

### Experimental Example 2: Alternating Current Impedance Analysis

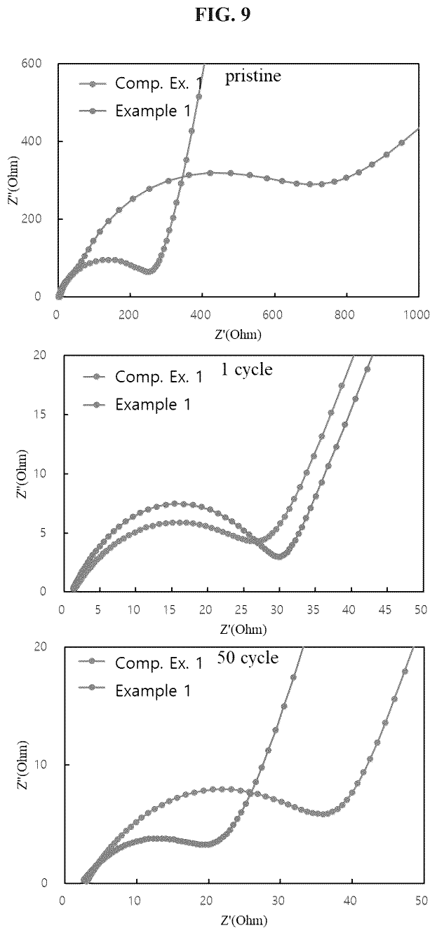

Results of electrochemical impedance spectroscopy (EIS) analysis according to cycling of half-cells according to Examples 1 to 3 of the present invention and Comparative Example 1 are shown in FIG. 9.

From EIS results analyzed before cycling, a charge transfer resistance of the half-cell according to Example 1 was measured to be approximately 725.7Ω, which is higher than approximately 267.4Ω measured for the half-cell according to Comparative Example 1.

This result can be interpreted as being due to void spaces present inside the anode active material particles used in Example 1, which act as charge transfer resistance.

In EIS results obtained after one cycle, lithium-ion transport pathways were activated, and charge transfer resistance was significantly reduced in both the cell according to Example 1 and the cell according to Comparative Example 1, showing values of approximately 27.3Ω and approximately 22.1Ω, respectively.

In particular, compared to the charge transfer resistance before cycling, the charge transfer resistance after one cycle was reduced to a greater extent in the cell according to Example 1.

In results obtained after 50 cycles, a charge transfer resistance value of the half-cell according to Comparative Example 1 (approximately 36.3Ω) was higher than a charge transfer resistance value of the cell according to Example 1 (approximately 20.0Ω).

This result can be interpreted as follows: in the half-cell according to Comparative Example 1, which employs an anode active material prepared from a non-porous commercial silicon microparticle-carbon composite (SiMP@C), electrode pulverization occurs as cycling proceeds because volume expansion cannot be accommodated. In contrast, in the half-cell according to Example 1, which includes porous silicon particles having mesoporous micropores and coated with carbon-based particles, a porous structure including micropores inside the composite alleviates volume expansion, thereby resulting in a markedly improved structural stability of the electrode.

### Experimental Example 3: Evaluation of Electrochemical Characteristics of Lithium Secondary Battery

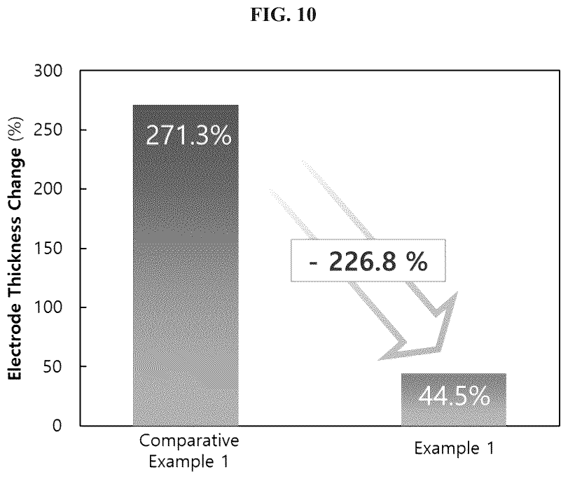

After the charge-discharge cycling test of Experimental Example 1, thickness changes of electrode cross sections included in the secondary batteries according to Comparative Example 1 (SiMP@C) and Example 1 (v-pSi@C (15 vol %)) were measured using SEM, and the results are shown in FIG. 10.

In the electrode according to Comparative Example 1, cracks were generated in a cross section of the electrode due to volume expansion after 100 cycles, and it can be confirmed that the electrode thickness increased by approximately 271.3% compared to that before cycling.

As charge and discharge cycles accumulate, the electrode is pulverized and a conductive network is lost, thereby causing a rapid decrease in capacity as cycling proceeds.

In the electrode according to Example 1 of the present invention, the thickness after 100 cycles increased by approximately 44.5% compared to that before cycling, showing a markedly smaller thickness change than the electrode according to Comparative Example 1.

Accordingly, since micropores present inside the anode active material according to Example 1 of the present invention effectively absorb volume expansion of silicon during charge and discharge, it can be interpreted that, when the anode active material according to the present invention is used as an anode for a secondary battery, high capacity and long cycle life characteristics can be achieved.

Meanwhile, the secondary battery may include the above-described anode active material for a secondary battery, or may include an anode for a secondary battery manufactured using the above-described anode active material.

Through the above Experimental Examples, it can be confirmed that, in the anode active material for a secondary battery and the method for manufacturing the same according to one embodiment of the present invention, conventional volume expansion issues can be alleviated, electrode pulverization caused by volume expansion can be prevented, and problems of shortened battery cell lifetime resulting from such electrode pulverization can be resolved.

Although the present invention has been described with reference to embodiments illustrated in the drawings, these embodiments are merely exemplary. Those skilled in the art will understand that various modifications and equivalent embodiments may be made therefrom. Accordingly, the true technical scope of the present invention should be determined by the technical spirit of the appended claims.

What is claimed is:

1. An anode active material for a secondary battery, comprising:
porous silicon particles; and
carbon-based particles surrounding at least a portion of the porous silicon particles,
wherein mesopores are included inside a plurality of the porous silicon particles surrounded by the carbon-based particles.

2. The anode active material of claim 1,
wherein the porous silicon particles include mesopores having a size of approximately 12 to approximately 145 nm.

3. The anode active material of claim 2,
wherein the porous silicon particles consist of small silicon primary particles having a size of approximately 10 to approximately 60 nm.

4. The anode active material of claim 1,
wherein the anode active material has a pore volume in a range of approximately 0.1 to approximately 0.5 cm³/g.

5. The anode active material of claim 1,
wherein the carbon-based particles surround a surface of the porous silicon particles and are bonded to mesopores formed on the surface of the porous silicon particles.

6. A method for manufacturing an anode active material for a secondary battery, comprising:
an impregnation step of impregnating porous silicon particles with a polymer template;
a coating step of coating carbon-based particles onto the porous silicon particles impregnated with the polymer template; and
a carbonization step of carbonizing the porous silicon particles coated with the carbon-based particles subsequent to the coating step.

7. The method of claim 6,
wherein, in the impregnation step, a pore volume formed inside the anode active material is controllable by adjusting an amount of the polymer template impregnated into the pores of the porous silicon particles.

8. The method of claim 6,
wherein the impregnation step comprises impregnating the polymer template in an amount of approximately 5 to approximately 50 vol % of a pore volume of the porous silicon particles.

9. The method of claim 6,
wherein the impregnation step comprises:
a dissolving step of dissolving the polymer template in a solvent;
an absorption step of adding a predetermined amount of a polymer template solution to the porous silicon particles in small portions to be absorbed into pores of the porous silicon particles; and
a drying step of evaporating the solvent after the absorption step to obtain the porous silicon particles in which the polymer is impregnated.

10. The method of claim 6,
wherein the coating step comprises:
an addition step of adding the carbon-based particles to a solvent;
a mixing step of dispersing or stirring the impregnated porous silicon particles, the carbon-based particles, and the solvent;
a bonding step of inducing physical or chemical bonding of the carbon-based particles at a predetermined temperature after the mixing step; and
an evaporation step of removing the solvent after the bonding step to surround the impregnated porous silicon particles with the carbon-based particles.

11. The method of claim 6,
wherein, after the coating step, the impregnated polymer template is thermally decomposed and the carbon-based particles bonded to the porous silicon particles are carbonized by heating under an oxygen-free inert gas atmosphere or a mixed atmosphere of an inert gas and hydrogen.

12. The method of claim 11,
wherein the carbonization step is performed by increasing a temperature to a range of approximately 200 to approximately 1200° C.

13. The method of claim 12,
further comprising, after the carbonization step, a process of additionally pulverizing the anode active material and sieving the pulverized material to obtain particles having a size of approximately 5 to approximately 45 μm.

14. A secondary battery comprising an anode active material, the anode active material including:
porous silicon particles; and
carbon-based particles surrounding at least a portion of the porous silicon particles,
wherein mesopores are included inside a plurality of the porous silicon particles surrounded by the carbon-based particles.

15. The secondary battery of claim 14,
wherein the porous silicon particles include mesopores having a size of approximately 12 to approximately 145 nm.

16. The secondary battery of claim 14,
wherein the porous silicon particles are composed of small silicon primary particles having a size of approximately 10 to approximately 60 nm.

17. The secondary battery of claim 14,
wherein the anode active material has a pore volume in a range of approximately 0.1 to approximately 0.5 cm³/g.

18. The secondary battery of claim 14,
wherein the carbon-based particles surround a surface of the porous silicon particles and are bonded to micropores formed on the surface of the porous silicon particles.
